(19) United States
(12) Patent Application Publication
(10) Pub. No.: US 2021/0131734 A1
(43) Pub. Date: May 6, 2021

(54) FURNACE SYSTEM AND METHOD FOR OPERATING A FURNACE

(71) Applicant: Linde Aktiengesellschaft, München (DE)

(72) Inventor: Thomas NIEHOFF, München (DE)

(21) Appl. No.: 16/639,627

(22) PCT Filed: Jul. 12, 2018
(86) PCT No.: PCT/EP2018/025192

§ 371 Date: Feb. 17, 2020

(30) Foreign Application Priority Data
Aug. 17, 2017 (DE) 10 2017 007 799.1

(51) Int. Cl. F27D 19/00; F23D 14/02; F23N 5/00

(52) U.S. Cl. CPC F27D 19/00; F23D 14/02; F27D 2019/0015; F27D 2019/0034; F23N 5/003

(57) ABSTRACT

The invention relates to a method for operating a furnace (12), comprising a furnace chamber (14), which is heated by means of at least one burner (16), wherein the method comprises a monitoring of a combustion in the furnace chamber (14), and monitoring a calorific value of a fuel determined for the burner (16). The invention further relates to a furnace system (10), and to a control unit (24).

The invention relates to a method, a control unit for operating a furnace, and a furnace system. In particular, the invention is in the field of operating a furnace for melting metal-containing material.

In order to melt metal-containing material, the metal-containing material, which is also referred to as charge material or feedstock, is typically introduced into the furnace chamber of a furnace. The furnace chamber is heated by means of a burner to such high temperatures that the metal-containing constituents of the charge material at least partially melt and separate from other constituents of the charge material, while impurities in the charge material, which may be present in particular as organic constituents, are preferably combusted in the furnace chamber.

The burner used for heating the furnace chamber is typically heated with a fuel, such as a fuel gas or a heating gas, which is supplied to the burner in addition to oxygen so that the burner preferably generates a flame by means of which the furnace chamber is heated.

The amount of heat that the burner must provide in the furnace chamber for the economical melting/heating of metals/glass in the furnace chamber often depends upon the feedstock and its characteristics. Thus, for example, in the case of a feedstock which has a significant portion of organic constituents, a lesser amount of heat introduced into the furnace chamber by the burner can be sufficient than in the case of a feedstock having a lower portion of organic constituents, since the combustion of at least some of these organic constituents of the feedstock in the furnace chamber likewise releases thermal energy which can contribute to an increase in temperature and/or to combustion. It is therefore known in the prior art to adapt the heat input by means of the burner to the combustion taking place in the furnace chamber, and, in particular, to adapt or regulate the quantity of fuel and/or oxygen supplied to the burner as a function of the organic portion in the feedstock.

Conventionally, the exhaust gases produced during combustion in the furnace chamber are often monitored for this purpose. For example, concentrations of certain gases and/or particles in the exhaust gases are measured, such as carbon monoxide, oxygen, carbon dioxide, and/or nitrogen oxides.

Methods for operating a furnace are known from the documents EP 2 278 245 A1 and U.S. Pat. No. 8,163,062 B2, for example.

The disadvantage of the methods known from the prior art is that, on the basis of the exhaust gases which arise in the furnace chamber, one cannot always reliably assess the cause to which a change in the combustion process in the furnace chamber is ascribable, and which parameters must be readjusted in order to avoid such changes.

The invention is therefore based upon the technical aim of providing a method for operating a furnace and a furnace system which enable more reliable regulation and/or control of the combustion process in the furnace chamber, and have greater flexibility with regard to the fuel that can be used.

This aim is achieved by a method, a control unit, and a furnace system having the features of the respective independent claims. Preferred embodiments are the subject matter of the dependent claims and the following description.

According to a first aspect, the invention relates to a method for operating a furnace with a furnace chamber which is heated by means of at least one burner, wherein the method comprises monitoring combustion in the furnace chamber and monitoring a calorific value of a fuel intended for the burner.

According to a further aspect, the invention relates to a control unit for operating a furnace with a furnace chamber which is heated by means of at least one burner, wherein the control unit is designed to carry out a method according to one of the preceding claims.

According to a further aspect, the invention relates to a furnace system having a furnace with a furnace chamber, a burner for heating the furnace chamber, and a control unit according to the invention.

The combustion in the furnace chamber can be monitored continuously over time and/or at discrete points in time—for example, at regular time intervals. The combustion is preferably monitored on the basis of measurements of exhaust gases which occur during combustion in the furnace chamber.

The monitoring of the calorific value of the fuel intended for the burner can also take place continuously over time and/or at discrete points in time—for example, at regular time intervals.

The invention offers the advantage that monitoring the calorific value of the fuel intended for the burner enables the burner, or the performance of the burner, or the heat input into the furnace chamber by the burner, to be monitored without the ascertained measured values being influenced in the process by any measurement distortions. In contrast to conventional methods in which the burner is often also regulated exclusively by monitoring the combustion in the furnace chamber or by monitoring the exhaust gases which arise during combustion in the furnace chamber, influences which affect combustion in the furnace chamber do not cause any distortion in the measurement of the burner performance or in the heat input into the furnace chamber by the burner. Thus, for example, the burner performance or the heat input by the burner can also then be ascertained correctly and its operation can continue undisturbed if there are changes in the combustion in the furnace chamber, such as from a variation in the organic portion in the feedstock and/or by the entry of infiltrated air into the furnace chamber. Such interfering influences can significantly influence the combustion in the furnace chamber and, conventionally, cannot be distinguished from a variation in burner operation by monitoring the combustion in the furnace chamber. Since, according to the invention, the calorific value of the fuel intended for the burner is monitored independently of the combustion in the furnace chamber, disturbing influences in the furnace chamber can, in contrast, be distinguished from a change in the operation of the burner or the calorific value of the fuel, and thus, preferably, do not lead to an unnecessary and/or incorrect adaptation of the fuel supply and/or oxygen supply to the burner.

Furthermore, the invention offers the advantage that changes in the calorific value of the fuel intended for the burner can preferably be detected before the fuel is supplied to the burner, and thus the fuel supply and/or the supply of oxygen to the burner, which is required for fuel combustion, can be adapted. This makes it possible to optimize the operation of the burner in terms of efficiency and to regulate the combustion in such a way that the burner can be operated as desired or as needed. Furthermore, this makes it possible to use fuels for combustion in the burner which, for example, have a non-constant or a fluctuating calorific value and thus may require a regular and/or continuous readjustment of the fuel supply and/or the supply of oxygen to the burner for the efficient operation of the burner. In particular, the invention can thus offer the advantage that low-grade fuels, which are distinguished, for example, by a fluctuating and/or varying calorific value, can also be combusted without having to accept or risk reductions in the efficiency of the operation of the burner and/or of the furnace system, or even damage to the burner and/or furnace system.

For example, such low-grade fuels can be biogases, and/or lean gas, or pyrolysis gas, or coke furnace gas, since biogases frequently do not have a constant calorific value; instead, different biogas supplies can have different calorific values, such that fluctuations or variations in the calorific value can occur given a continuous supply of biogas as the fuel into the burner. The invention thus offers the advantage that it enables the operation of a furnace or of a furnace system with comparatively low-grade biogas, as a result of which cost savings can be achieved compared to the supply of higher-grade fuels to the furnace or furnace system, which admittedly have lower fluctuations in their calorific value, but are also often significantly more expensive to purchase.

The fact that the fuel has a fluctuating and/or varying calorific value means that different volumes or supplies of fuel can have a different calorific value, which can be supplied to the burner in chronological succession, for example.

Furthermore, the invention offers the advantage that the energy input into the furnace chamber or in the furnace chamber by the burner or the combustion performance of the burner can be ascertained and can, in particular, be kept constant, since the burner can be readjusted according to the ascertained calorific value. In addition, the invention offers the advantage that it is also possible to adapt the flame characteristic or combustion characteristic and set it by means of a corresponding regulation of the burner.

By also monitoring the combustion in the furnace chamber, it is also possible to adapt the burner performance and/or combustion performance according to the heat provided from the feedstock due to the combusting organic portions and the preheated combustion air which is fed into the furnace chamber via the burner.

Preferably, an additional fuel may be added to the burner via an additional fuel supply in order to adjust or change the calorific value of the fuel supplied to the burner. In particular, the additional fuel may comprise or consist of a particularly high-quality fuel, such as natural gas, and/or hydrogen, and/or propane, and/or other hydrocarbons. This offers the advantage that low-grade fuels, i.e., fuels with a low calorific value, can also be combusted in the burner, wherein a higher grade fuel can be added to increase and/or adjust the calorific value if a higher calorific value is needed and/or to compensate for calorific value fluctuations.

This offers the advantage that combustion can be optimized both in the burner and in the furnace chamber, even when fuel gases with a fluctuating calorific value are used or combusted. In addition, this makes it possible, when combusting and/or melting a feedstock of unknown organic content, to adapt the supply of fuel in order to take into account the actual organic portion in the feedstock. For example, the feedstock can have paints, and/or oils, and/or fats, and/or other organic adhesions which have a high calorific value and thus make it appear advantageous to feed a fuel with a lower calorific value into the burner and/or to feed a smaller quantity of fuel into the burner. Furthermore, this offers the advantage that combustion can also be optimized to the desired combustion conditions so that combustion in the furnace chamber can be adjusted or adapted—for example, for charging and/or heating, and/or melting, and/or alloying, and/or maintaining heat, and/or casting, and/or sintering the refractory lining. Combustion can thereby also be optimized for reheating and/or for thermal treatment, such as for homogenization and/or for soft annealing of metallic and non-metallic materials, such as glass and/or minerals, in the feedstock. Optimization of combustion for maximizing the metallic yield from the feedstock can also be optimized. In addition, the invention makes it possible to reduce emissions, such as carbon dioxide, and/or nitrogen oxides, and/or carbon monoxide, and/or dust. The introduction of oxygen into the furnace chamber can also be controlled or minimized by monitoring the calorific value in order, for example, to reduce or avoid undesired oxidation of the metallic feedstock, and/or dissolution of the oxygen in the liquid, metallic feedstock. Furthermore, the invention offers the advantage that the consumption of fuel can be reduced by monitoring the calorific value.

Preferably, a metallic feedstock is at least partially melted in the furnace chamber when the furnace is operating. In other words, the furnace or the furnace system is operated in such a way that a metallic feedstock, or feedstock with metallic portions, can be melted therein, and/or impurities—in particular, organic impurities—can be combusted.

The method preferably comprises regulating the burner as a function of the combustion in the furnace chamber and as a function of the calorific value of the fuel intended for the burner. In other words, the findings obtained when monitoring the combustion in the furnace chamber and when monitoring the calorific value of the fuel intended for the burner are used for controlling and/or regulating the burner. The combustion in the furnace chamber can thereby be optimized, and the efficiency of the furnace or of the furnace system thus be improved.

The regulation of the burner preferably comprises regulating an oxygen supply to the burner and/or regulating a fuel supply to the burner. This can make it possible to optimize the combustion of the fuel in the burner and thus to provide an improved heat yield, and/or a desired type of flame, and/or lower pollutant emissions by the burner.

Preferably, monitoring the calorific value of the fuel intended for the burner comprises precombusting a part of the fuel intended for the burner. For this purpose, for example, the part, intended for the precombustion, of the fuel intended for the burner can be diverted from the remaining part of the fuel intended for the burner before the remaining part of the part of the fuel intended for the burner is supplied to the burner. By precombusting a part of the fuel before the remaining part of the fuel is supplied to the burner, the calorific value of the fuel can be directly ascertained or monitored, and the fuel supplied to the burner can thus be characterized in order, for example, to regulate the burner as well as possible and to set the best possible ratio of fuel and oxygen, and/or additional fuel, and/or additional oxygen supplied to the burner. In this case, it is preferable to ascertain an oxygen demand for the precombustion, with which the oxygen demand for a best possible or desired combustion of the remaining part of the fuel burner can preferably be derived. For example, in order to ascertain the best possible oxygen demand or the best possible oxygen supply and/or fuel supply into the burner, the exhaust gas produced during precombustion can be characterized or analyzed in a monitored manner, which can be done, in particular, using concentrations and/or portions of the parts present in the exhaust gas, such as, in particular, using carbon monoxide, and/or carbon dioxide, and/or hydrogen, and/or oxygen.

Furthermore, it is preferable to regulate an oxygen supply into the furnace chamber as a function of the combustion in the furnace chamber. For example, the furnace system can have one or more oxygen lances by means of which oxygen and/or other combustion-promoting substances, such as air, can be fed directly into the furnace chamber without these first having to be supplied to the burner. The oxygen and/or other combustion-promoting substances are preferably introduced directly into the furnace chamber as a function of the combustion in the furnace chamber, which was characterized or analyzed, for example, by monitoring the combustion in the furnace chamber or the exhaust gases produced thereby. This offers the advantage that the adjustment, and/or the regulation, and/or the operation of the burner can take place to an even greater extent independently of other parameters influencing the combustion in the furnace chamber. Preferably, the monitoring of the combustion in the furnace chamber comprises a measurement of at least one exhaust gas parameter of exhaust gases produced during combustion in the furnace chamber, wherein, preferably, at least one exhaust gas parameter comprises a concentration of carbon monoxide, and/or oxygen, and/or carbon dioxide, and/or nitrogen oxide.

A control unit and/or computation unit according to the invention is designed—in particular, programmed—to carry out a method according to the invention.

The implementation of the method in the form of a computer program product is also advantageous, since this yields particularly low costs—particularly if an executing control unit is additionally used for further tasks and is therefore present anyway. Suitable data carriers for providing the computer program are preferably machine-readable storage media, such as, in particular, magnetic, optical, and electrical storage, such as hard disks, flash drives, EEPROM's, DVD's, and the like. A download of a program via computer networks (internet, intranet, etc.) is also possible.

Further advantages and embodiments of the invention will be apparent from the description and the accompanying drawings.

It is to be understood that the features mentioned above and the features yet to be explained below may be used, not only in the particular combination given, but also in other combinations or by themselves, without departing from the scope of the present invention.

The invention is schematically illustrated in the drawings using an exemplary embodiment and is described below with reference to the drawings.

### DESCRIPTION OF THE FIGURES

FIG. 1 shows a furnace system according to a first preferred embodiment.

FIG. 2 shows a furnace system according to a second preferred embodiment.

### DETAILED DESCRIPTION OF THE DRAWINGS

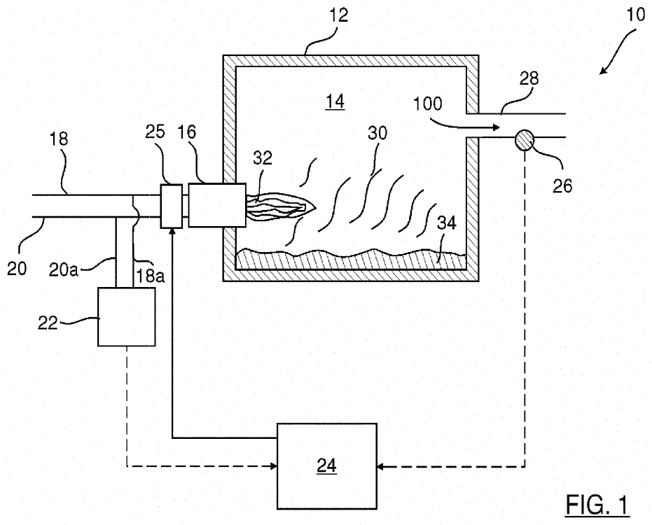

FIG. 1 shows a schematic illustration of a furnace system 10 according to a first preferred embodiment. The furnace system 10 has a furnace 12 which forms or has a furnace chamber 14. Furthermore, the furnace system 10 has a burner 16 which is arranged on or integrated into the furnace 12 and is designed to heat the furnace chamber 14. The burner is supplied with fuel or oxygen, which are intended for combustion in the burner 16, via a fuel supply line or fuel line 18 and an oxygen supply line or oxygen line 20, in order to cause heat to be input via the burner 16 into the furnace chamber 14. In this case, pure oxygen does not necessarily have to be supplied to the burner 16 via the oxygen line 20, but a mixture having oxygen may, for example, also be sufficient to be combusted in the burner 16 with the fuel from the fuel line 18. For example, the burner 16 may be supplied with air via the fuel line 20.

Both the fuel line 18 and the oxygen line 20 have a branch 18a or 20a, respectively, via which fuel or oxygen is diverted from the fuel line 18 or the oxygen line 20 and supplied to a precombustor 22. The portions of the fuel and of the oxygen which are diverted via the branches 18a and 20a from the fuel or oxygen to be supplied to the burner 16 are preferably very low, so that, nevertheless, the greatest portion of the fuel and oxygen to be supplied to the burner is available for combustion in burners. Precombustion of the diverted portions of the fuel and oxygen then takes place in the precombustor 22, wherein the calorific value of fuel is ascertained or monitored. In particular, the diversion of fuel and oxygen can take place continuously—in particular, when the burner 16 is in operation—in order to preferably allow permanent or continuous monitoring of the fuel and/or oxygen that is to be supplied or is supplied to the burner 16. The findings concerning the fuel ascertained during precombustion in the precombustor 22 can then be forwarded by the precombustor 22 to a control unit 24 which can, for example, store, and/or evaluate, and/or further use the data, and/or measured values, and/or findings received from the precombustor 22.

In the embodiment shown, the control unit 24 is, furthermore, connected to an exhaust gas sensor 26 which is arranged in and/or at an exhaust gas outlet 28 of the furnace 12 and is designed to at least partially measure or monitor the exhaust gases 30 flowing in the direction 100 out of the furnace chamber 14, and, in this way, to monitor or characterize the combustion in the furnace chamber 14. The exhaust gas sensor 26 preferably transmits data and/or findings about the combustion in the furnace chamber 14 to the control unit 24, which data and/or findings can then be stored, and/or evaluated, and/or further used by the control unit 24.

The control unit 24 is designed in such a way that the control unit 24 regulates the burner 16 on the basis of or as a function of the data or findings concerning the calorific value of the fuel transmitted by the precombustor 22, and on the basis of or as a function of the data or findings concerning the combustion in the furnace chamber 14 ascertained by the exhaust gas sensor 26 (fuel quantity, composition and/or stoichiometry) in order to achieve optimal combustion of the fuel in the burner 16 and, accordingly, optimal generation of heat and/or flame 32 and, in this way, optimize the combustion process or melting process of the feedstock 34 in the furnace chamber.

For example, the burner 16 may have means by which the combustion of the fuel in the burner 16, and/or the supply of fuel to the burner 16, and/or the supply of oxygen to the burner 16 can be adapted by means of regulation by the control unit 24. Alternatively or additionally, such means may be provided separately from the burner 16—for example, via controllable valves (not shown) in the fuel line 18 and/or in the oxygen line 20.

The control unit 24 can be designed to calculate an energy content of the heated and/or molten metal or feedstock based upon the employed fuel and/or oxygen amounts, and to propose from this calculated energy content the next steps of the melting cycle, such as a charge release for the next batch and/or combustion performance and/or an oxygen quantity, a temperature curve to be attained, and/or a composition of the furnace atmosphere to be provided or exhaust gas values to be achieved.

In addition, the furnace system 10 has a control path 25 for a volume flow and/or pressure of the oxygen or the air and/or the fuel, which are supplied to the burner 16. This control path 25 can, for example, be controlled or regulated or monitored by the control unit 24.

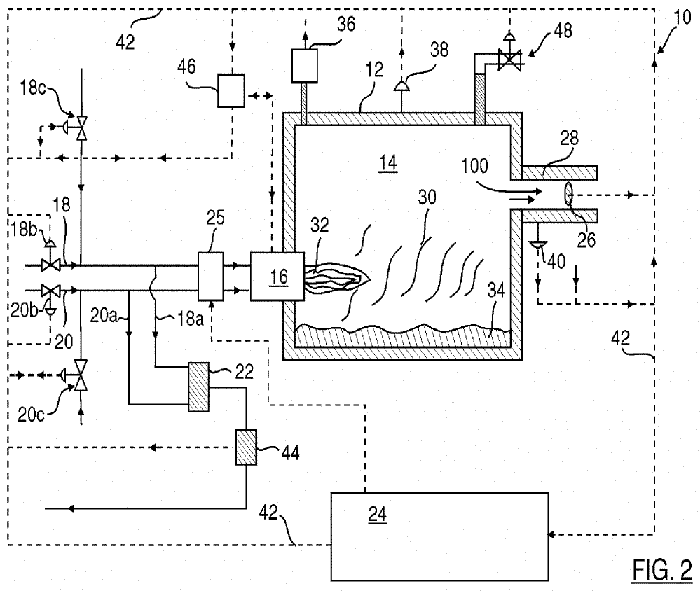

FIG. 2 shows a schematic representation of a furnace system 10 according to a second preferred embodiment. Explanations regarding elements which have already been explained with reference to FIG. 1 also apply to the embodiment shown in FIG. 2, unless they are replaced by other explanations.

The shown furnace system 10 has a plurality of sensors which serve to monitor the combustion in the furnace chamber 14 and/or the calorific value. For example, the furnace system 10 has a pressure sensor 36 which is designed to ascertain a pressure difference between the interior of the furnace chamber 14 and the outside environment of the furnace 12. In addition, the furnace system 10 has one or more furnace temperature sensors 38 which are used to measure the temperature in and/or on the furnace chamber 14. In addition, an exhaust gas temperature sensor 40 is arranged at the exhaust gas outlet 28 to ascertain the temperature of the exhaust gases 30 flowing through the exhaust gas outlet 28. The furnace system 10 also has a further exhaust gas sensor 26 which is designed, in particular, to ascertain portions or concentrations of various gases in the exhaust gases 30, such as the concentrations of carbon monoxide, and/or oxygen, and/or carbon dioxide, and/or nitrogen oxides.

All said sensors are connected in a communications network to the control unit 24 which, among other things, receives and processes, and/or forwards, and/or stores the measured values or data ascertained by said sensors.

Furthermore, the furnace system 10 according to the second preferred embodiment has a precombustion analyzer 44 which is designed to analyze the exhaust gases from precombustion produced in the precombustor 22 and, in particular, to ascertain the portions or concentrations of carbon monoxide, and/or carbon dioxide, and/or hydrogen in the exhaust gases from precombustion, and also to provide them to the control unit 24 via the communications network 42.

The control unit 24 is designed in this case to ascertain suitable parameters for the regulation of the combustion furnace chamber 14 and, in particular, for the operation of the burner 16 on the basis of the received data or measured values of the aforementioned sensors and the precombustion analyzer 44, and to appropriately control the corresponding elements in order to correspondingly regulate the desired combustion in the furnace chamber 14 and the combustion in the burner 16. For this purpose, for example, the burner 16 can be connected to the communications network 42 or to the control unit 24 via a separate burner regulator 46 so that the burner regulator 46 controls or regulates or adapts the combustion process in the burner 16 on the basis of control commands which the burner regulator 46 receives from the control unit 24. In addition, the burner regulator 46 may be designed to return data to the control unit 24 via the communications network 42, which data, for example, provide information about the operation, and/or the behavior, and/or possible disturbances of the burner 16. According to other preferred embodiments, the burner regulator 46 or its functionality can also be integrated into the control unit 24 or be taken over by the control unit 24.

Furthermore, the furnace system 10 has controllable valves 18b and 20b by means of which the flows of fuel and oxygen via the fuel line 18 or the oxygen line 20 can be adapted, and/or controlled, and/or regulated in order to thereby be able to adapt to the operation or the combustion process in burner 16. Furthermore, via an additional controllable or regulatable additional fuel line 18c, a further additional fuel can be added to the fuel supplied via the fuel line 18 to the burner 16 in order, for example, to change the calorific value of the fuel. For example, when a low-grade fuel is supplied to the burner 16 via the fuel line 18, natural gas, and/or hydrogen, and/or propane, and/or other hydrocarbons can be added to the fuel in order to increase its calorific value and adapt it to the desired or required calorific value. Accordingly, the oxygen line 20 has an additional line 20c via which, for example, pure oxygen can be added to the gas flowing through the oxygen line 20 as needed in order, for example, to allow efficient combustion of the fuel and the optionally added, additional fuel in the burner 16. These controllable or regulatable additional lines 18c and 20c are also connected via the communications network 42 to the control unit 24 and can preferably be controlled or regulated thereby.

In addition, the furnace system 10 has a controllable and/or regulatable oxygen lance 48 via which oxygen and/or an oxygen-containing gas mixture can be directly injected into the furnace chamber 14 in order, for example, to supply oxygen to the combustion in the furnace chamber 14 without it having to pass through the burner 16.

### REFERENCE NUMBERS

10 Furnace system
12 Furnace
14 Furnace chamber
16 Burner
18 Fuel line
20 Oxygen line
22 Precombustor
24 Control unit
25 Mechanical control path for air/oxygen and fuel
26 Exhaust gas sensor
28 Exhaust gas outlet
30 Exhaust gases
32 Flame
34 Feedstock
36 Pressure sensor
38 Furnace temperature sensor
40 Exhaust gas temperature sensor
42 Communications network
44 Precombustion analyzer
46 Burner regulator
48 Oxygen lance
100 Flow direction of the exhaust gases

1. Method for operating a furnace (12) having a furnace chamber (14) which is heated by means of at least one burner (16), wherein the method comprises monitoring combustion in the furnace chamber (14) and monitoring a calorific value of a fuel intended for the burner (16).

2. Method according to claim 1, further comprising regulating the burner (16) as a function of the combustion in the furnace chamber (14) and as a function of the calorific value of the fuel intended for the burner (16).

3. Method according to claim 2, wherein the regulation of the burner (16) comprises regulating an oxygen supply to the burner (16), and/or regulating a fuel supply to the burner (16), and/or regulating an additional fuel supply.

4. Method according to claim 1, wherein monitoring the calorific value of the fuel intended for the burner (16) comprises precombusting a part of the fuel intended for the burner (16), and preferably comprises ascertaining an oxygen demand for the precombustion.

5. Method according to claim 4, wherein the part of the fuel intended for the burner (16) is diverted for the precombustion from the remaining part of the fuel intended for the burner (16) before the remaining part of the part of the fuel intended for the burner (16) is supplied to the burner (16).

6. Method according to claim 1, further comprising regulating an oxygen supply into the furnace chamber (14) as a function of the combustion in the furnace chamber (14).

7. Method according to claim 1, wherein monitoring the combustion in the furnace chamber (14) comprises measuring at least one exhaust gas parameter of exhaust gases which are produced during combustion in the furnace chamber (14), wherein preferably at least one exhaust gas parameter comprises a concentration of carbon monoxide, and/or oxygen, and/or carbon dioxide, and/or nitrogen oxide.

8. Method according to claim 1, wherein a metallic feedstock is at least partially melted in the furnace chamber (14) when the furnace (12) is operating.

9. Control unit (24) for operating a furnace (12) having a furnace chamber (14) which is heated by means of at least one burner (16), wherein the control unit (24) is designed to carry out a method according to claim 1.

10. Control unit (24) according to claim 9, wherein the control unit comprises a control device and/or several control devices connected via a communications link.

11. Furnace system (10) comprising:
a furnace (12) having a furnace chamber (14);
a burner (16) for heating the furnace chamber (14);
a control unit (24) according to claim 9.

12. Furnace system (10) according to claim 11, further comprising a precombustor (22) designed to precombust a part of the fuel intended for the burner (16), and wherein the furnace system (10) is preferably designed to ascertain an oxygen demand for the precombustion.
